(19) United States
(12) Patent Application Publication
(10) Pub. No.: US 2010/0024656 A1
(43) Pub. Date: Feb. 4, 2010

(54) ALCOHOLIZATION DEVICE

(76) Inventor: Edward I-Hua Chen, Taipei City (TW)

Correspondence Address: APEX JURIS, PLLC, 12733 LAKE CITY WAY NORTHEAST, SEATTLE, WA, 98125, US

(21) Appl. No.: 12/185,569

(22) Filed: Aug. 4, 2008

(51) Int. Cl. C12C 13/00

(52) U.S. Cl. 99/276

(57) ABSTRACT

The present invention discloses an alcoholization device comprising a frame and a chip. The chip is inlaid inside the frame, and the frame covers the rim of the chip to protect the chip. The chip emits a light having a wavelength of between 2500 and 3500 μm, which can accelerate the aging process of a farm product, such as wine or tea. The alcoholization device of the present invention can eliminate the sour and harsh tastes of wine or the unwanted smells of tea and present the flavor and fragrance thereof in a short time. Therefore, the present invention can use a shorter time to age farm products to a quality level that consumers can accept. Therefore, the present invention can fast promote the quality of wine and tea to meet the requirement of consumers.

### FIELD OF THE INVENTION

The present invention relates to an alcoholization device for farm products, particularly to an alcoholization device accelerating the aging of farm products, such as wine and tea.

### BACKGROUND OF THE INVENTION

“Store longer, smell better” is a Chinese proverb about wine. After long-time storage, the sour and harsh tastes of wine will gradually decrease. Such a phenomenon is the so-called aging. For fermented teas, such as Puerh tea and black tea, aging also gradually eliminates various unwanted smells and presents the flavor and fragrance of tea. Therefore, the quality and price of wine or tea positively correlate with the time of aging.

With the development of economics, unrefined wine and tea no more satisfy consumers. However, high-quality wine and tea need a long time of aging. Thus, the manufacturer has to prepare a vast storage space, which greatly raises the production cost. Besides, the longer the storage, the more likely the unexpected incident. Thus, the supply of high-quality wine and tea is usually insufficient to meet the demand of market, and the price thereof always stays high. Therefore, the traditional aging technology of sealing-up has the disadvantages of time-consuming, low productivity and high price.

### SUMMARY OF THE INVENTION

The primary objective of the present invention is to provide an alcoholization device to accelerate the aging of farm products and promote the productivity of high-quality aged farm products.

To achieve the abovementioned objective, the present invention proposes an alcoholization device, which applies to accelerate the aging process of farm products and comprises a frame and a chip. The frame has a receiving space, and the frame encircles the receiving space. The chip is inlaid in the receiving space, and the rim of the chip is covered by the frame. The chip emits a light having a wavelength of between 2500 and 3500 μm, which can accelerate the aging process of farm products.

The light having a wavelength of between 2500 and 3500 μm emitted by the alcoholization device of the present invention can eliminate the sour and harsh tastes of wine or the unwanted smells of tea and present the flavor and fragrance thereof in a shorter time. Therefore, the present invention can reduce the production time of wine and tea and fast promote the quality thereof.

### BRIEF DESCRIPTION OF THE DRAWINGS

FIG. 1 is a diagram schematically showing the structure of an alcoholization device according to a first embodiment of the present invention;

FIG. 2 is an exploded view schematically showing the structure of the alcoholization device according to the first embodiment of the present invention;

FIG. 3 is a diagram schematically showing one application of the first embodiment of the present invention;

FIG. 4 is a diagram schematically showing the structure of an alcoholization device according to a second embodiment of the present invention; and

FIG. 5 is a diagram schematically showing another application of the third embodiment of the present invention.

### DETAILED DESCRIPTION OF THE PREFERRED EMBODIMENTS

Below, the preferred embodiments are described in detail in cooperation with the drawings to make easily understand the objectives, characteristics and achievements of the present invention.

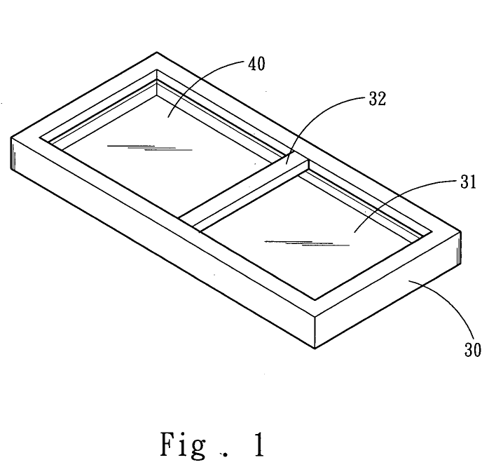

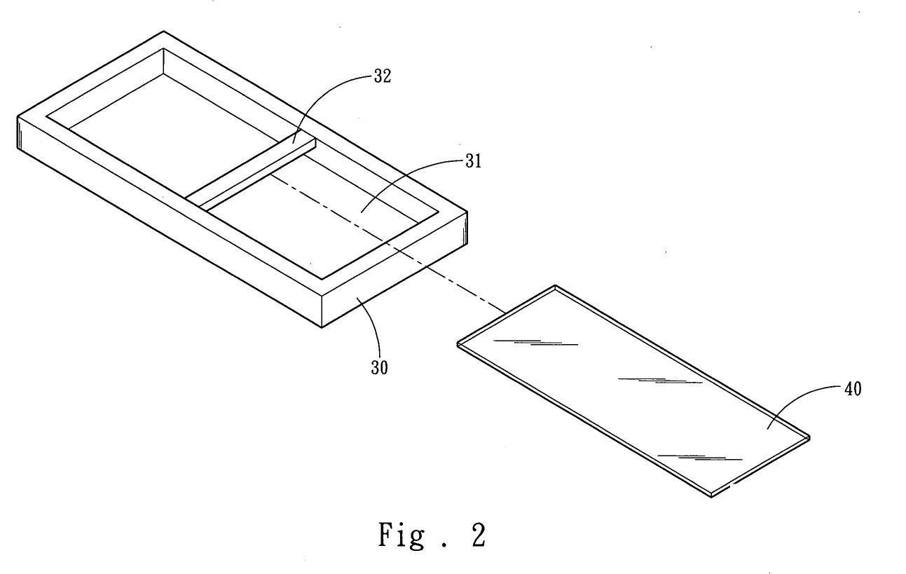

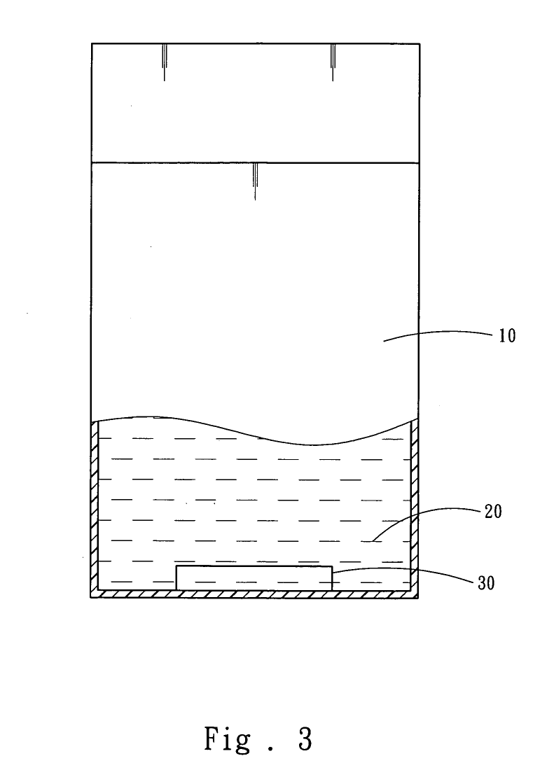

Refer to FIG. 1, FIG. 2 and FIG. 3. An alcoholization device of the present invention is placed inside a sealed container 10 containing a farm product 20, such as wine or tea, to accelerate the aging process of the farm product 20. The alcoholization device of the present invention comprises a frame 30 and a chip 40. The frame 30 has a receiving space 31, and the frame 30 encircles the receiving space 31. The chip 40 is inlaid in the receiving space 31, and the rim of the chip 40 is covered by the frame 30. The chip 40 emits a light having a wavelength of between 2500 and 3500 μm, which can accelerate the aging process of the farm product 20. Besides, the frame 30 has a protection rod 32 spanning the receiving space 31 to protect the chip 40 against the damage of external force.

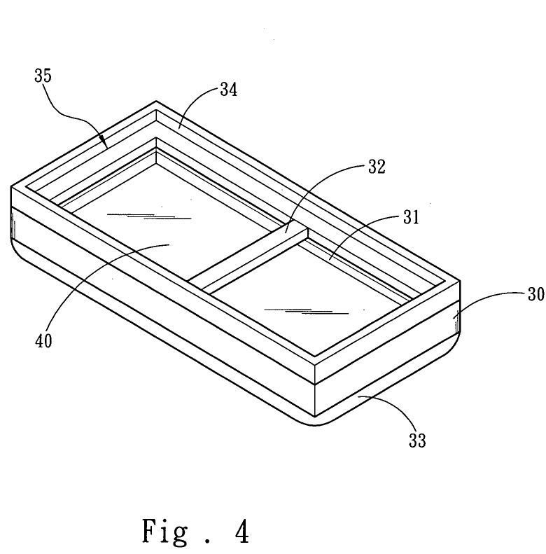

Refer to FIG. 4 for another embodiment of the present invention. In this embodiment, the frame 30 has a baseplate 33 arranged in one side of the receiving space 31. A protrudent wall 34 protrudes from the rim of the frame 30 in the other side of the receiving space 31 toward the direction opposite to the baseplate 33. The protrudent wall 34 and the baseplate 33 cooperate to form a containing space 35. The chip 40 is arranged in the bottom of the containing space 35, and the farm product 20 is placed inside the containing space 35. The containing space 35 can contain only a small amount of the farm product 20, such as tea. If the containing space 35 can be sealed, it can contain a liquid farm product 20, such as wine.

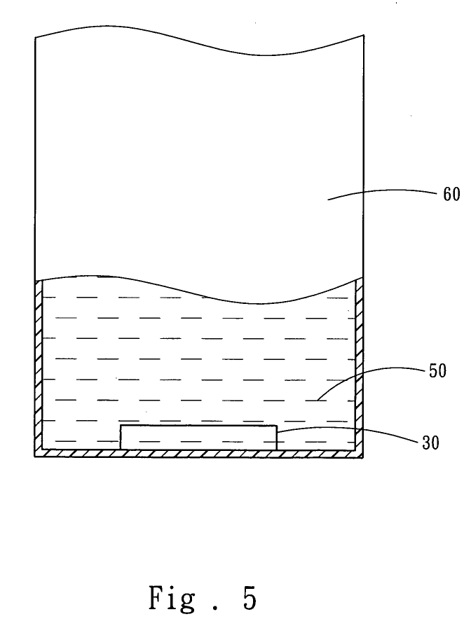

Refer to FIG. 5. The chip 40 together with the frame 30 is placed inside a container 60 containing water 50. After a period of time of the oscillation induced by the electromagnetic wave, the molecular clusters of water 50 will be separated into tiny molecular groups that human bodies can easily absorb.

In conclusion, the present invention provides the alcoholization device whose chip 40 emits a light having a wavelength of between 2500 and 3500 μm to accelerate the aging process of the farm product 20, such as wine or tea. When applied to wine, the present invention can fast eliminate the sour and harsh tastes of wine. After having been processed by the present invention for several years, the wine will present a flavor exceeding that presented by the wine having been processed by the traditional technology for the same time. When applied to tea, the present invention can fast eliminate various unwanted smells and present the flavor and fragrance of tea. Therefore, the alcoholization device of the present invention can promote the quality of wine and tea in a short time to meet the requirement of consumers.

What is claimed is:

1. An alcoholization device comprising
a frame having a receiving space and encircling said receiving space; and
a chip inlaid in said receiving space with the rim thereof covered by said frame, and emitting a light having a wavelength of between 2500 and 3500 μm.

2. The alcoholization device according to claim 1, wherein said frame has a baseplate arranged in one side of said receiving space; a protrudent wall protrudes from the rim of said frame in the other side of said receiving space toward the direction opposite to said baseplate; said protrudent wall and said baseplate cooperate to form a containing space; said chip is arranged in the bottom of said containing space, and a farm product is placed inside said containing space.

3. The alcoholization device according to claim 2, wherein said farm product is wine.

4. The alcoholization device according to claim 2, wherein said farm product is tea.

5. The alcoholization device according to claim 1, wherein said frame has a protection rod spanning said receiving space.
